(19) United States
(12) Patent Application Publication
(10) Pub. No.: US 2024/0410985 A1
(43) Pub. Date: Dec. 12, 2024

(54) DAMAGE PROTECTION FOR OPTICAL SYSTEMS

(71) Applicant: Allegro MicroSystems, LLC, Manchester, NH (US)

(72) Inventor: Nanditha Dissanayake, Portland, OR (US)

(73) Assignee: Allegro MicroSystems, LLC, Manchester, NH (US)

(21) Appl. No.: 18/330,555

(22) Filed: Jun. 7, 2023

(51) Int. Cl. G01S 7/481; G01S 17/88

(52) U.S. Cl. CPC G01S 7/4816; G01S 17/88

(57) ABSTRACT

Methods and apparatus for an optical system that can include a receiver to protect an optical sensor for damage. In one embodiment, a optical receiver includes a lens to receive an optical signal and a non-linear optical (NLO) element to receive an output from the lens, where the NLO element has an intensity dependent optical index. The receiver can include an optical sensor and an aperture located between the optical sensor and the NLO element.

### BACKGROUND

As is known in the art, optical systems can detect light incident on a sensor. LIDAR systems, for example, transmit laser pulses that can be reflected by targets to generate signal return. In some situations, return pulses may have an energy level that can damage one or more of the receiving components, such as a sensor. For example, avalanche photodiodes can be damaged by optical power density or irradiance levels above certain levels.

### SUMMARY

Example embodiments of the disclosure provide methods and apparatus for an optical system, such as a LIDAR system, having optical damage protection against high-energy optical pulses. In embodiments, active and/or passive optical-limiter components are optimized for short-wave infrared wavelengths, e.g., 900-1550 nm, nano-second, e.g., 2-5 ns, pulse-widths. In embodiments, a primary optical-limiter component is composed of non-linear optical (NLO) material. Embodiments of the system can comprise an NLO material having certain characteristics. In some embodiments, an NLO material has an intensity dependent refractive index following the optical Kerr effect. In some embodiments, an NLO material has an optical-intensity dependent absorption coefficient which gives rise to two-photon absorption or other form of reverse-saturable absorption process.

In some embodiments, an NLO optical-system allows transmission of incoming below optical-damage threshold laser input to the LIDAR sensor with minimum attenuation. In some embodiments, an NLO optical-system defocuses or redirects incoming above an optical-damage threshold optical input to reduce irradiance below optical damage threshold of the sensor. In some embodiments, an NLO optical-system absorbs above an optical-damage threshold optical input to reduce irradiance below optical damage threshold of the sensor. In some embodiments, an NLO optical-system generates an ensemble of optical frequencies as a supercontinuum from the incoming above optical-damage threshold input which spreads the pulse energy across a spectrum attenuating irradiance at the input optical frequency incident on the LIDAR sensor. In some embodiments, an NLO optical-system absorbs peak-energy spatial-region of the above optical damage threshold input Gaussian pulse thereby lowering the integrated optical pulse-energy below the optical damage threshold of the LIDAR sensor. In some embodiments, NLO materials that demonstrate optical Kerr and two-photon absorption comprise GaN, Silica glass, and Germania-core fiber. In some embodiments, NLO optical fibers comprise As—Se, As—S, and/or As—Te photonic crystal fibers.

In some embodiments, a primary optical-limiter components comprise linear-optical (LO) materials where the LO comprises an n:m splitter with n<<m where the incoming laser pulse is split and sensed in one branch (n) and the other branch sends the m/(n+m) fraction of the signal to the LIDAR sensors through a time t optical delay line. If incoming laser pulse energy is above the optical damage threshold, the LIDAR sensor is deactivated by limiting the bias voltage or limiting the supply current for protection within a time t′<<t or; an optical switch is active to attenuate or blocks incoming optical signal from reaching the LIDAR sensor within a time t′ which is t″<<t wherein the optical switch can be an acousto-optical modulator (AOM), piezoelectric resonator, a mechanical shutter, and/or micro electro mechanical system (MEMS) deflection mirror.

In one aspect, a LIDAR optical receiver system comprises: an optic to receive an optical signal; an optical filter to control an output from the optic; and an optical sensor to receive an output from the optical filter. A system can further include one or more of the following features: the optic comprises a lens and the optical filter comprises a non-linear optical (NLO) element to receive an output from the lens, wherein the NLO element has an intensity dependent optical index, an aperture between the NLO element and the optical sensor, the NLO element is configured to attenuate the output from lens when the output from the lens is above an optical damage threshold, the NLO element is configured to attenuate the output from the lens by increasing divergence, an optical pump coupled to the NLO element to bias the optical damage threshold, the NLO element is configured to attenuate the output from the lens when the output from the lens is above an optical damage threshold, the NLO element is configured to attenuate by increasing absorption, the NLO element is configured as a reverse-saturable absorber via a two-photon absorption above a critical optical irradiance at an input optical-frequency, an optical pump coupled to the NLO element to bias the optical damage threshold, the optic comprises a lens to receive an optical signal and, the optical filter comprises a non-linear optical (NLO) element to receive an output from the lens, wherein the NLO element has an intensity dependent optical index, and further including: a photodetector coupled to the NLO element; an optical source to transmit an optical signal through the NLO element to the photodetector; and a controller coupled to an output of the photodetector and to the sensor, wherein the controller is configured to control the sensor based on the output of the photodiode, the controller is configured to deactivate the sensor based on the output of the photodiode, the optic comprises a collimator to receive an incoming optical pulse and the optical filter comprises a non-linear optical fiber to receive a signal from the collimator, wherein the fiber is configured to output a supercontinuum of coherent optical frequencies if the signal from the collimator is above a threshold, and further including: a passband filter to filter an output from the optical fiber; a sensor to receive an output from the passband filter; and a laser pump coupled to the optical fiber, the optic comprises a collimator to receive an incoming optical pulse and the optical filter comprises a non-linear optical fiber to receive an output from the collimator, wherein the fiber includes a core and shell configuration and is configured to absorb energy from the output from the collimator if a peak intensity of the output from the collimator is above a threshold, and further including: a laser pump coupled to the optical fiber, the optic comprises a collection optic to receive an optical input signal and the optical filter comprises a splitter to split an output from the collection optic into first and second signals in a ratio of n:m, and further including: a photodetector to receive the first signal; a delay module to receive the second signal; a controller coupled to the photodetector; and a sensor to receive an output from the delay module, and/or a switch coupled to the controller, wherein the switch is coupled between the sensor and the delay module.

In another aspect, a method comprises: employing an optic to receive an optical signal in a LIDAR optical receiver system; employing an optical filter to control an output from the optic; and, employing an optical sensor to receive an output from the optical filter. A method can further include one or more of the following features: the optic comprises a lens and the optical filter comprises a non-linear optical (NLO) element to receive an output from the lens, wherein the NLO element has an intensity dependent optical index, an aperture between the NLO element and the optical sensor, the NLO element is configured to attenuate the output from lens when the output from the lens is above an optical damage threshold, the NLO element is configured to attenuate the output from the lens by increasing divergence, an optical pump coupled to the NLO element to bias the optical damage threshold, the NLO element is configured to attenuate the output from the lens when the output from the lens is above an optical damage threshold, the NLO element is configured to attenuate by increasing absorption, the NLO element is configured as a reverse-saturable absorber via a two-photon absorption above a critical optical irradiance at an input optical-frequency, an optical pump coupled to the NLO element to bias the optical damage threshold, the optic comprises a lens to receive an optical signal and, the optical filter comprises a non-linear optical (NLO) element to receive an output from the lens, wherein the NLO element has an intensity dependent optical index, and further including: a photodetector coupled to the NLO element; an optical source to transmit an optical signal through the NLO element to the photodetector; and a controller coupled to an output of the photodetector and to the sensor, wherein the controller is configured to control the sensor based on the output of the photodiode, the controller is configured to deactivate the sensor based on the output of the photodiode, the optic comprises a collimator to receive an incoming optical pulse and the optical filter comprises a non-linear optical fiber to receive a signal from the collimator, wherein the fiber is configured to output a supercontinuum of coherent optical frequencies if the signal from the collimator is above a threshold, and further including: a passband filter to filter an output from the optical fiber; a sensor to receive an output from the passband filter; and a laser pump coupled to the optical fiber, the optic comprises a collimator to receive an incoming optical pulse and the optical filter comprises a non-linear optical fiber to receive an output from the collimator, wherein the fiber includes a core and shell configuration and is configured to absorb energy from the output from the collimator if a peak intensity of the output from the collimator is above a threshold, and further including: a laser pump coupled to the optical fiber, the optic comprises a collection optic to receive an optical input signal and the optical filter comprises a splitter to split an output from the collection optic into first and second signals in a ratio of n:m, and further including: a photodetector to receive the first signal; a delay module to receive the second signal; a controller coupled to the photodetector; and a sensor to receive an output from the delay module, and/or a switch coupled to the controller, wherein the switch is coupled between the sensor and the delay module.

### BRIEF DESCRIPTION OF THE DRAWINGS

The foregoing features of this disclosure, as well as the disclosure itself, may be more fully understood from the following description of the drawings in which:

FIG. 1 is a block diagram of an example an optical system having optical damage protection;

FIG. 2 shows an example receiver for an optical sensor system having NLO based optical damage protection;

FIGS. 2A and 2B are schematic diagrams of example LIDAR systems having optical damage protection;

FIG. 3 shows example optical damage threshold information 300 in photons/cm² as a function of laser pulse repetition frequency (PRF) of 200-μm diameter single APD and a 6000-μm² area APD;

FIG. 4 shows simulated APD junction temperatures at different input peak irradiances and pulse repetition frequencies (PRF);

FIG. 5 shows an example embodiment of controlling the applied optical bias to bring the NLO threshold closer to the input irradiance of the LIDAR input;

FIG. 6 shows another embodiment of an example receiver for an optical sensor system, such as a LIDAR system, having NLO based optical damage protection;

FIG. 7 shows another embodiment of an example receiver for an optical sensor system, such as a LIDAR system, having NLO based optical damage protection;

FIG. 8 shows another embodiment of an example receiver for an optical sensor system, such as a LIDAR system, having optical protection with non-linear fiber;

FIG. 8A shows a graphical representation of an example high energy pulse at frequency f, FIG. 8B shows a supercontinuum of the pulse of FIG. 8A into a large frequency band, and FIG. 8C shows a pulse at frequency f after filtering the signal of FIG. 8B;

FIGS. 9, 9A, and 9B show another embodiment of an example receiver for an optical sensor system, such as a LIDAR system, having optical protection with a core-shell non-linear optical fiber;

FIGS. 10A and 10B show further embodiments of example receivers for an optical sensor system, such as a LIDAR system, having optical protection with collection optics; and

FIG. 11 is a schematic representation of an example computer that can perform at least a portion of the processing described herein.

### DETAILED DESCRIPTION

Prior to describing example embodiments of the disclosure some information is provided. Laser ranging systems can include laser radar (ladar), light-detection and ranging (lidar), and rangefinding systems, which are generic terms for the same class of instrument that uses light to measure the distance to objects in a scene. This concept is similar to radar, except optical signals are used instead of radio waves. Similar to radar, a laser ranging and imaging system emits a pulse toward a particular location and measures the return echoes to extract the range.

As used herein, the term “light” refers to electromagnetic radiation spanning the ultraviolet, visible, and infrared wavebands, of any wavelength between 100 nm and 3,000 nm.

Laser ranging systems generally work by emitting a laser pulse and recording the time it takes for the laser pulse to travel to a target, reflect, and return to a photoreceiver. The laser ranging instrument records the time of the outgoing pulse—either from a trigger or from calculations that use measurements of the scatter from the outgoing laser light—and then records the time that a laser pulse returns. The difference between these two times is the time of flight to and from the target. Using the speed of light, the round-trip time of the pulses is used to calculate the distance to the target.

Lidar systems may scan the beam across a target area to measure the distance to multiple points across the field of view, producing a full three-dimensional range profile of the surroundings. More advanced flash lidar cameras, for example, contain an array of detector elements, each able to record the time of flight to objects in their field of view.

When using light pulses to create images, the emitted pulse may intercept multiple objects, at different orientations, as the pulse traverses a 3D volume of space. The echoed laser-pulse waveform contains a temporal and amplitude imprint of the scene. By sampling the light echoes, a record of the interactions of the emitted pulse is extracted with the intercepted objects of the scene, allowing an accurate multi-dimensional image to be created. To simplify signal processing and reduce data storage, laser ranging and imaging can be dedicated to discrete-return systems, which record only the time of flight (TOF) of the first, or a few, individual target returns to obtain angle-angle-range images. In a discrete-return system, each recorded return corresponds, in principle, to an individual laser reflection (i.e., an echo from one particular reflecting surface, for example, a tree, pole or building). By recording just a few individual ranges, discrete-return systems simplify signal processing and reduce data storage, but they do so at the expense of lost target and scene reflectivity data. Because laser-pulse energy has significant associated costs and drives system size and weight, recording the TOF and pulse amplitude of more than one laser pulse return per transmitted pulse, to obtain angle-angle-range-intensity images, increases the amount of captured information per unit of pulse energy. All other things equal, capturing the full pulse return waveform offers significant advantages, such that the maximum data is extracted from the investment in average laser power. In full-waveform systems, each backscattered laser pulse received by the system is digitized at a high sampling rate (e.g., 500 MHz to 1.5 GHZ). This process generates digitized waveforms (amplitude versus time) that may be processed to achieve higher-fidelity 3D images.

Of the various laser ranging instruments available, those with single-element photoreceivers generally obtain range data along a single range vector, at a fixed pointing angle. This type of instrument—which is, for example, commonly used by golfers and hunters—either obtains the range (R) to one or more targets along a single pointing angle or obtains the range and reflected pulse intensity (I) of one or more objects along a single pointing angle, resulting in the collection of pulse range-intensity data, (R,I)ᵢ, where i indicates the number of pulse returns captured for each outgoing laser pulse.

More generally, laser ranging instruments can collect ranging data over a portion of the solid angles of a sphere, defined by two angular coordinates (e.g., azimuth and elevation), which can be calibrated to three-dimensional (3D) rectilinear cartesian coordinate grids; these systems are generally referred to as 3D lidar and ladar instruments. The terms “lidar” and “ladar” are often used synonymously and, for the purposes of this discussion, the terms “3D lidar,” “scanned lidar,” or “lidar” are used to refer to these systems without loss of generality. 3D lidar instruments obtain three-dimensional (e.g., angle, angle, range) data sets. Conceptually, this would be equivalent to using a rangefinder and scanning it across a scene, capturing the range of objects in the scene to create a multi-dimensional image. When only the range is captured from the return laser pulses, these instruments obtain a 3D data set (e.g., angle, angle, range)ₙ, where the index n is used to reflect that a series of range-resolved laser pulse returns can be collected, not just the first reflection.

Some 3D lidar instruments are also capable of collecting the intensity of the reflected pulse returns generated by the objects located at the resolved (angle, angle, range) objects in the scene. When both the range and intensity are recorded, a multi-dimensional data set [e.g., angle, angle, (range-intensity)] is obtained. This is analogous to a video camera in which, for each instantaneous field of view (FOV), each effective camera pixel captures both the color and intensity of the scene observed through the lens. However, 3D lidar systems, instead capture the range to the object and the reflected pulse intensity.

Lidar systems can include different types of lasers, including those operating at different wavelengths, including those that are not visible (e.g., those operating at a wavelength of 840 nm or 905 nm), and in the near-infrared (e.g., those operating at a wavelength of 1064 nm or 1550 nm), and the thermal infrared including those operating at wavelengths known as the “eyesafe” spectral region (i.e., generally those operating at a wavelength beyond 1300-nm), where ocular damage is less likely to occur. Lidar transmitters are generally invisible to the human eye. However, when the wavelength of the laser is close to the range of sensitivity of the human eye—roughly 350 nm to 730 nm—the energy of the laser pulse and/or the average power of the laser must be lowered such that the laser operates at a wavelength to which the human eye is not sensitive. Thus, a laser operating at, for example, 1550 nm, can—without causing ocular damage—generally have 200 times to 1 million times more laser pulse energy than a laser operating at 840 nm or 905 nm.

One challenge for a lidar system is detecting poorly reflective objects at long distance, which requires transmitting a laser pulse with enough energy that the return signal—reflected from the distant target—is of sufficient magnitude to be detected. To determine the minimum required laser transmission power, several factors must be considered. For instance, the magnitude of the pulse returns scattering from the diffuse objects in a scene is proportional to their range and the intensity of the return pulses generally scales with distance according to 1/R\hat{ }4 for small objects and 1/R\hat{ }2 for larger objects; yet, for highly-specularly reflecting objects (i.e., those objects that are not diffusively-scattering objects), the collimated laser beams can be directly reflected back, largely unattenuated. This means that—if the laser pulse is transmitted, then reflected from a target 1 meter away—it is possible that the full energy (J) from the laser pulse will be reflected into the photoreceiver; but—if the laser pulse is transmitted, then reflected from a target 333 meters away—it is possible that the return will have a pulse with energy approximately 10\hat{ }12 weaker than the transmitted energy. To provide an indication of the magnitude of this scale, the 12 orders of magnitude (10\hat{ }12) is roughly the equivalent of: the number of inches from the earth to the sun, 10× the number of seconds that have elapsed since Cleopatra was born, or the ratio of the luminous output from a phosphorescent watch dial, one hour in the dark, to the luminous output of the solar disk at noon.

In many cases of lidar systems highly-sensitive photoreceivers are used to increase the system sensitivity to reduce the amount of laser pulse energy that is needed to reach poorly reflective targets at the longest distances required, and to maintain eyesafe operation. Some variants of these detectors include those that incorporate photodiodes, and/or offer gain, such as avalanche photodiodes (APDs) or single-photon avalanche detectors (SPADs). These variants can be configured as single-element detectors, segmented-detectors, linear detector arrays, or area detector arrays. Using highly sensitive detectors such as APDs or SPADs reduces the amount of laser pulse energy required for long-distance ranging to poorly reflective targets. The technological challenge of these photodetectors is that they must also be able to accommodate the incredibly large dynamic range of signal amplitudes.

As dictated by the properties of the optics, the focus of a laser return changes as a function of range; as a result, near objects are often out of focus. Furthermore, also as dictated by the properties of the optics, the location and size of the “blur”—i.e., the spatial extent of the optical signal—changes as a function of range, much like in a standard camera. These challenges are commonly addressed by using large detectors, segmented detectors, or multi-element detectors to capture all of the light or just a portion of the light over the full-distance range of objects. It is generally advisable to design the optics such that reflections from close objects are blurred, so that a portion of the optical energy does not reach the detector or is spread between multiple detectors. This design strategy reduces the dynamic range requirements of the detector and prevents the detector from damage.

Acquisition of the lidar imagery can include, for example, a 3D lidar system embedded in the front of car, where the 3D lidar system, includes a laser transmitter with any necessary optics, a single-element photoreceiver with any necessary dedicated or shared optics, and an optical scanner used to scan (“paint”) the laser over the scene. Generating a full-frame 3D lidar range image—where the field of view is 20 degrees by 60 degrees and the angular resolution is 0.1 degrees (10 samples per degree)—requires emitting 120,000 pulses [(20*10*60*10)=120,000)]. When update rates of 30 frames per second are required, such as is required for automotive lidar, roughly 3.6 million pulses per second must be generated and their returns captured.

There are many ways to combine and configure the elements of the lidar system—including considerations for the laser pulse energy, beam divergence, detector array size and array format (single element, linear, 2D array), and scanner to obtain a 3D image. If higher power lasers are deployed, pixelated detector arrays can be used, in which case the divergence of the laser would be mapped to a wider field of view relative to that of the detector array, and the laser pulse energy would need to be increased to match the proportionally larger field of view. For example—compared to the 3D lidar above—to obtain same-resolution 3D lidar images 30 times per second, a 120,000-element detector array (e.g., 200×600 elements) could be used with a laser that has pulse energy that is 120,000 times greater. The advantage of this “flash lidar” system is that it does not require an optical scanner; the disadvantages are that the larger laser results in a larger, heavier system that consumes more power, and that it is possible that the required higher pulse energy of the laser will be capable of causing ocular damage. The maximum average laser power and maximum pulse energy are limited by the requirement for the system to be eyesafe.

As noted above, while many lidar system operate by recording only the laser time of flight and using that data to obtain the distance to the first target return (closest) target, some lidar systems are capable of capturing both the range and intensity of one or multiple target returns created from each laser pulse. For example, for a lidar system that is capable of recording multiple laser pulse returns, the system can detect and record the range and intensity of multiple returns from a single transmitted pulse. In such a multi-pulse lidar system, the range and intensity of a return pulse from a from a closer-by object can be recorded, as well as the range and intensity of later reflection(s) of that pulse—one(s) that moved past the closer-by object and later reflected off of more-distant object(s). Similarly, if glint from the sun reflecting from dust in the air or another laser pulse is detected and mistakenly recorded, a multi-pulse lidar system allows for the return from the actual targets in the field of view to still be obtained.

The amplitude of the pulse return is primarily dependent on the specular and diffuse reflectivity of the target, the size of the target, and the orientation of the target. Laser returns from close, highly-reflective objects, are many orders of magnitude greater in intensity than the intensity of returns from distant targets. Many lidar systems require highly sensitive photodetectors, for example avalanche photodiodes (APDs), which along with their CMOS amplification circuits. So that distant, poorly-reflective targets may be detected, the photoreceiver components are optimized for high conversion gain. Largely because of their high sensitivity, these detectors may be damaged by very intense laser pulse returns.

For example, if an automotive equipped with a front-end lidar system were to pull up behind another car at a stoplight, the reflection off of the license plate may be significant—perhaps 10\hat{ }12 higher than the pulse returns from targets at the distance limits of the lidar system. When a bright laser pulse is incident on the photoreceiver, the large current flow through the photodetector can damage the detector, or the large currents from the photodetector can cause the voltage to exceed the rated limits of the CMOS electronic amplification circuits, causing damage. For this reason, it is generally advisable to design the optics such that the reflections from close objects are blurred, so that a portion of the optical energy does not reach the detector or is spread between multiple detectors.

However, capturing the intensity of pulses over a larger dynamic range associated with laser ranging may be challenging because the signals are too large to capture directly. One can infer the intensity by using a recording of a bit-modulated output obtained using serial-bit encoding obtained from one or more voltage threshold levels. This technique is often referred to as time-over-threshold (TOT) recording or, when multiple-thresholds are used, multiple time-over-threshold (MTOT) recording.

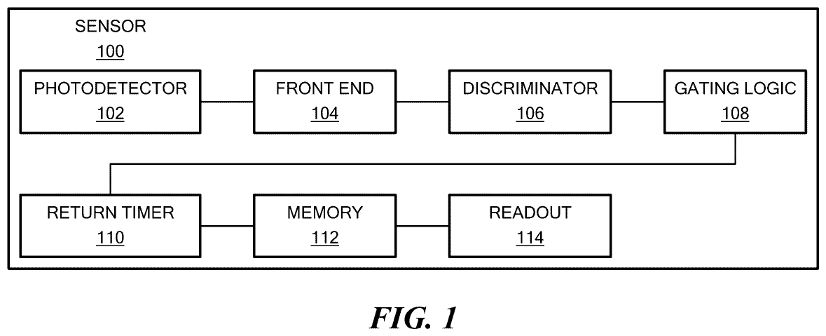

FIG. 1 shows an example optically protected LIDAR time-of-flight sensor 100 having photodetectors including a photodiode 102 array to detect photons reflected from a target illuminated with transmitted energy. A front-end circuit 104, which may include an amplifier for example, receives a current pulse generated by an optical pulse on the photodiode 102 and converts the current signal into an output, for example, an output voltage pulse. A discriminator circuit 106, such as a voltage discriminator, can determine if the current pulse, or its representation after signal conversion by the front-end circuit, is above one or more thresholds. Gating logic 108 receives an output from the discriminator 106 to match received signals with transmitted signals, for example. A return timer circuit 110, which can include a time-to-digital converter (TDC) for generating time-stamps, can determine the time from signal transmission to signal return so that a distance from the sensor to the target can be determined based on so-called time of flight. A memory 112 can store signal information, such as time of flight, time over threshold, and the like. A readout circuit 114—enables information to be read from the sensor.

A data processing and calibration circuit may be inserted between the memories 112 and the readout 114 which may perform any number of data correction or mapping functions. For example, the circuit may compare timing return information to timing reference information and convert timing return information into specific range information. Additionally, the circuit may correct for static or dynamic errors using calibration and correction algorithms. Other possible functions include noise reduction based on multi-return data or spatial correlation or objection detection. A possible mapping function may be to reshape the data into point-cloud data or to include additional probability data of correct measurement values based on additionally collected information from the sensor.

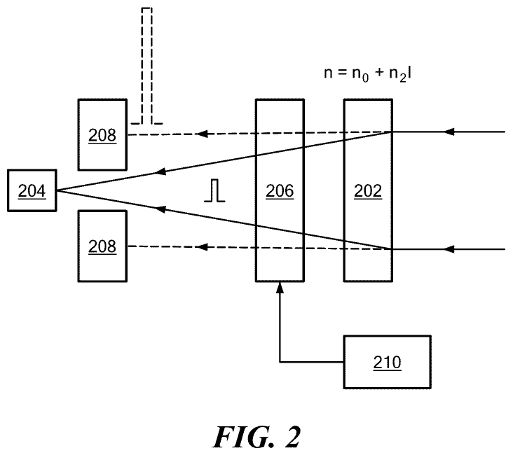

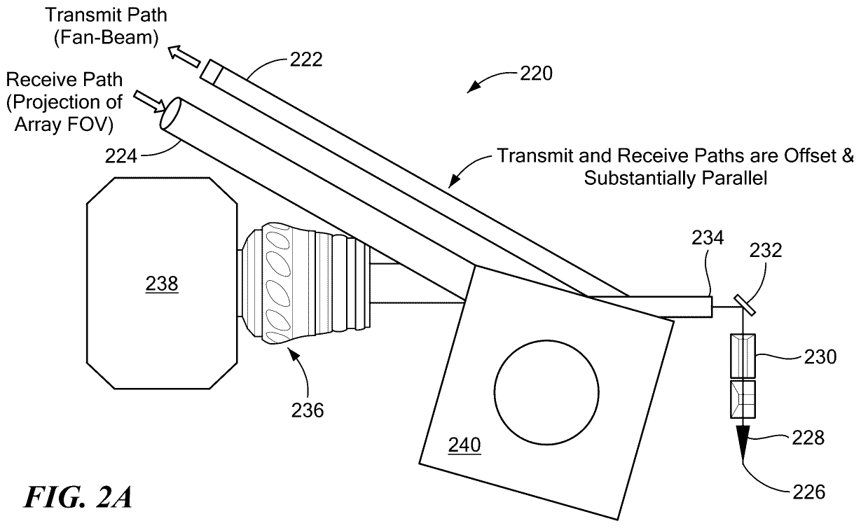

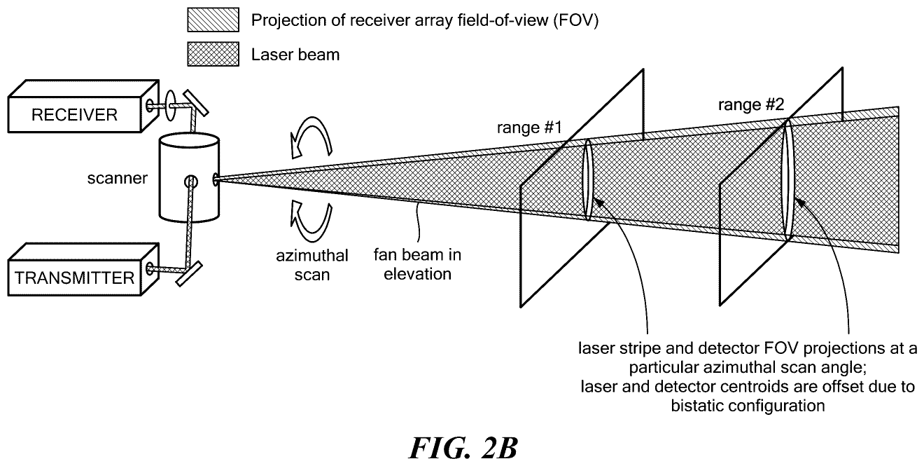

FIG. 2 shows an example receiver 200 for an optical sensor system, such as a LIDAR system, having NLO based optical damage protection. The receiver 200 includes a lens 202 having a suitable F/#, e.g., 1.4, to focus incoming laser return onto a sensor 204. A non-linear optical element 206 has an intensity-dependent optical index (n(ω)) given by n(ω)=n₀(ω)+n₂(ω)I, where n₀ is the linear optical index at optical frequency ω, n₂ is the non-linear optical index at optical frequency ω and I is the intensity.

The receiver 200 also includes an aperture 208 and an optional optical pump 210 to bias an optical threshold of the NLO element. When below optical damage threshold (I<I_{damage_threshold}), optical input 212 passes through the aperture 208 and is received by the sensor 204 without attenuation. When above optical damage threshold (I>I_{damage_threshold}), optical input 214 is received and a refractive index change in the NLO element 206 causes the optical input to diverge and get partially blocked by the aperture 208. As a result, the optical irradiance received at the sensor 204 drops below the optical damage threshold of the avalanche photodiodes (APDs) of the sensor 204, which prevents damage to the LIDAR sensor.

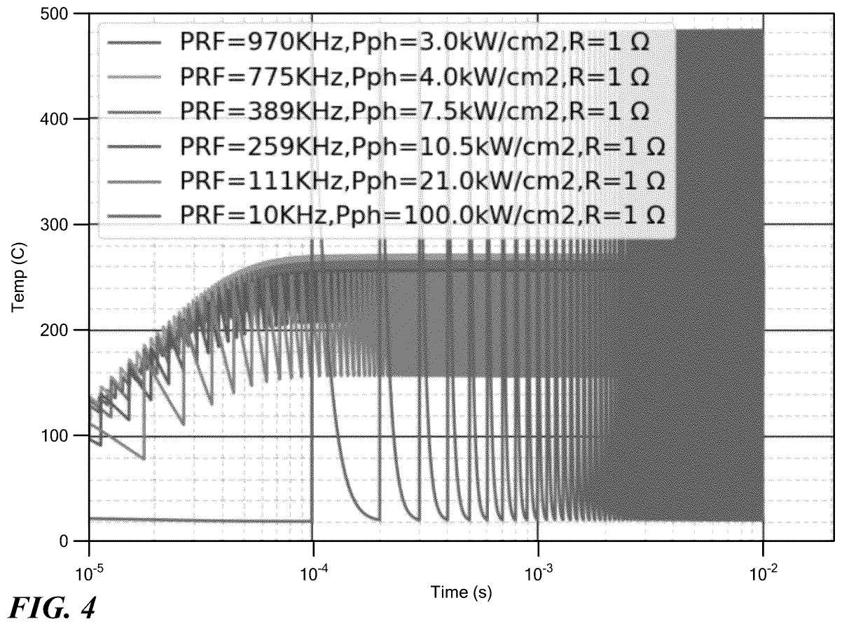

In example embodiments, the optical pump 210 brings the optical threshold of the NLO 206 near a critical level in which the non-linear properties are readily activated by the incoming high-energy optical pulses. In embodiments, the optical pump 210 comprises a femtosecond high peak power pump pulse laser operating at 100-MHz or higher pulse repetition frequency which operates at the exact same optical-frequency (ω) as the input pulse or at any other optical-frequency (ω′). Due to the higher pulse repetition frequency and narrow pulse width of the optical pump 210, pump-optical pulses readily interfere with the incoming laser pulses, which are 2-5 ns, for example, pulse width operating at less than 500-kHz pulse repetition frequency, returning from any distance target (or equivalent time interval). When a pump laser pulse and an input optical pulse constructively interfere, the total per pulse energy is above the threshold where the non-linear properties gets triggered as explained in FIG. 4.

The benefits of protecting sensors elements from damage will be readily apparent to one of ordinary skill in the art.

FIG. 2A shows an example bistatic lidar scanner system 220 having optical protection in accordance with illustrative embodiments of the disclosure. The transmit path 222 is the actual laser beam and the receive path 224 represents a projection of the receiver array's field-of-view (FOV) back through the optics. In other words, assume reversing all the light rays that can reach any portion of the array's active area and trace them back through the sensor's lens to get a projection of the array's FOV onto the scene.

The illustrative system 220 includes a fiber laser input 226, collimating lens 228, prism pair 230, fold mirror 232 and diffractive optical element 234, which generates a fan beam, coupled in series. On the receive side, an image-forming lens 236 is disposed in front of the receiver 238, which includes a detector array (not shown). A mirror 240, such as a spinning polygon mirror 242 can select the transmit/receive path.

The centers of the transmit and receive paths 222, 224 are offset and substantially parallel which may generate a range-parallax effect addressed by example embodiments of the disclosure. The scanner 220 preserves the ordering of the receive and transmit paths 222, 224 in the direction of their offset. In the illustrated embodiment, the receive path 224 is always to the left of the transmit path 222. As described more fully below, pixel configurations in the detector array can taper, or otherwise change in their characteristics, to one side of the array axis. In other embodiments, scanning systems a direction of range-parallax effect may be to both sides of the array axis. Folding mirrors, which preserve parallelism, may be used to meet the needs of a particular application.

FIG. 2B shows an example 1D scanned lidar system having optical protection in accordance with illustrative embodiments of the disclosure. As can be seen, centroids of the laser fan-beam and the projection of the receiver's FOV are offset. The receiver's FOV has to overlap the fan-beam in order to see the projected laser stripe. It is understood that the object is not seen unless the laser paints the object with a stripe, and that stripe is directly in the straight beam path of the laser. Thus, the offset and substantial parallelism of the transmit and receive paths is a geometric characteristic of this type of 1D scanned lidar system.

As used herein, it is understood that the term “optic” refers to a mechanical or electromechanical light-changing component external to a photoreceiver unless explicitly defined to be part of the photoreceiver. It is further understood that a photoreceiver may include a transparent window as part of the photoreceiver that is not considered to be an optic. For example, a photoreceiver may comprise a component sold as a package to which an optic may be attached and/or positioned in relation to the package to form a system. Unless defined otherwise, a photoreceiver comprises a photodetector array that can include a number of pixels.

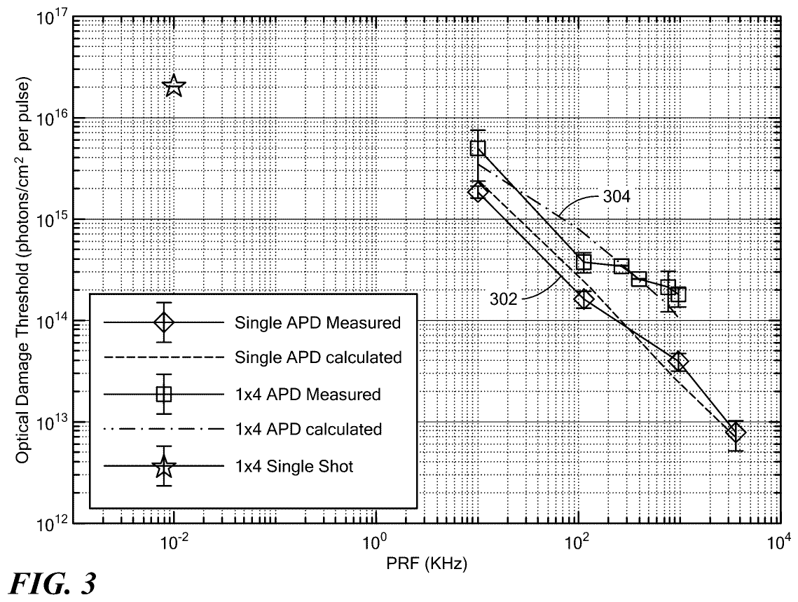

FIG. 3 shows example optical damage threshold information 300 in photons/cm² as a function of laser pulse repetition frequency (PRF) of 200-μm diameter single APD 302 with (diamonds and dashed line) and 144-μm×40-μm 1×4 APD 304 LIDAR sensors.

FIG. 4 shows simulated APD junction temperatures at different input peak irradiances and pulse repetition frequencies (PRF). As can be seen, the APD undergoes thermal runaway and gets damaged at above 250 C-degree average junction temperature. For 10 KHz PRFs, the instantaneous junction temp gets higher than 250-C but the time average temperature is more important of the thermal runaway process.

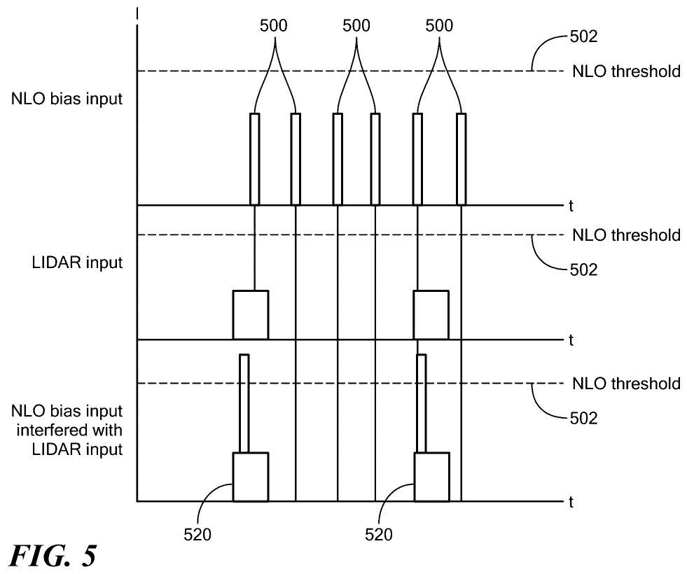

FIG. 5 shows an example embodiment of controlling the applied optical bias 500 to bring the NLO threshold 502 closer to the input irradiance of the LIDAR input. As shown in the top of the figure, a fs or ps pulse width high-pulse repetition frequency (100 MHz or higher) laser pumps the NLO components to an optical bias input just below the optical threshold 502 for non-linear activation. The middle of the figure shows the optical pulse return 510 in a LIDAR system with typical ns pulse width returns. The bottom of the figure shows the constructive interference of the both the bias optical pump pulse 500 with the LIDAR signal return 510 which create optical pulses 520 having peak values above the NLO threshold 502 leading to the generation of non-linear optical phenomena. Constructive interference occurs since the smaller pulse width of the bias laser guarantees that phase coherence is vacuously satisfied during the pulse-time of the wider ns input pulse.

FIG. 6 shows another embodiment of an example receiver 600 for an optical sensor system, such as a LIDAR system, having NLO based optical damage protection. A lens 602 with suitable F/# focuses incoming laser return onto a sensor 604. A non-linear optical element 606 functions as a reverse-saturable absorber via a two-photon absorption above a critical optical irradiance at the input optical-frequency. The two-photon non-linear optical transition rate R is given as a function of the two-photon absorption coefficient σ⁽²⁾, optical irradiance I, reduced plank's constant ℏ and optical frequency ω by σ⁽²⁾I²/ℏω. An optical pump 610 biases the optical threshold of the NLO element 606, as described above. If below an optical damage threshold (I<I_{damage_threshold}), optical input 612 is received and focused onto the sensor 604 without attenuation. If above optical damage threshold (I>I_{damage_threshold}), the optical input 614 is received and absorbed in the NLO material 606. As a result, the optical irradiance received at the sensor 604 drops below the optical damage threshold of the LIDAR sensor to prevent optical damage.

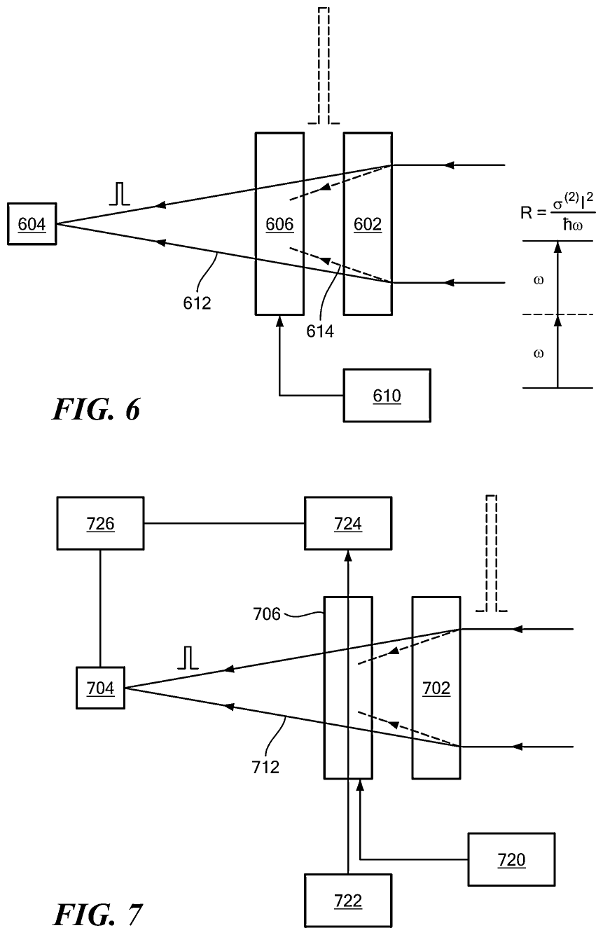

FIG. 7 shows another embodiment of an example receiver 700 for an optical sensor system, such as a LIDAR system, having NLO based optical damage protection. A lens 702 with a matching F/# collect input signal. An NLO optical element 706 has an intensity dependent refractive index n or an intensity dependent two-photon absorption coefficient σ⁽²⁾ and provides optical input 712 to a LIDAR sensor 704 An optical bias laser 720 sets the threshold for the non-linear processing. An external optical source 722, a photodetector 724, and a LIDAR sensor controller 726 combine to control processing of incident light. If an above threshold optical pulse is incident on the NLO optical element 706, the optical transmission from the optical source 722 to the photodetector 724 is affected due to absorption in the NLO material and the magnitude of the optical signal on the external photodetector 724 is reduced. The change in the photodetector 724 response is detected by controller 728, which immediately deactivates the LIDAR sensor 704 to prevent optical damage.

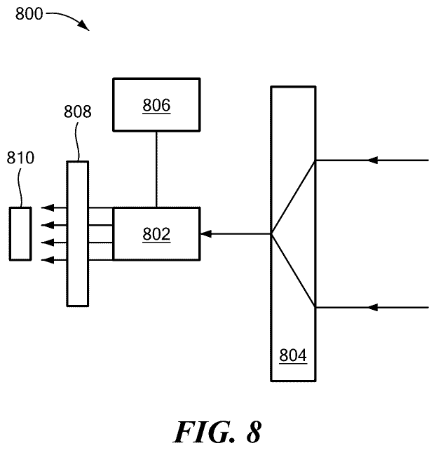

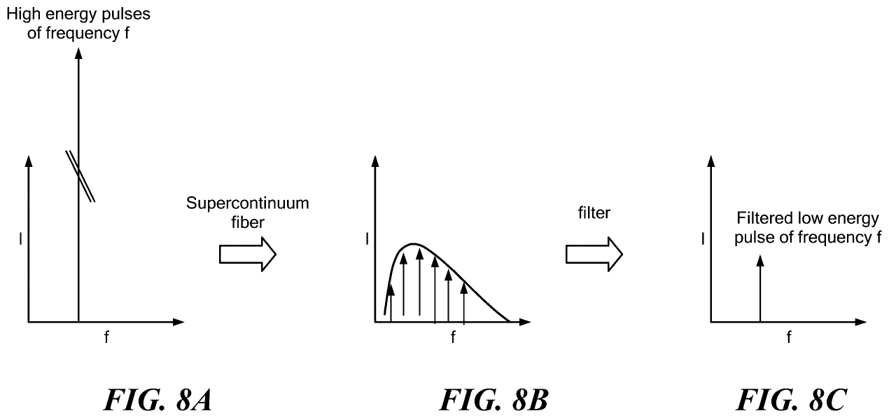

FIG. 8 shows another embodiment of an example receiver 800 for an optical sensor system, such as a LIDAR system, having optical protection with non-linear fiber 802. The incoming pulse is collected and collimated by a collimator 804 the output of which is sent to the non-linear optical fiber 802 to convert the optical pulses to a supercontinuum of coherent optical frequencies via non-linear optical process if the energy of the pulse is above a critical level. This critical threshold is set, for example, via a potential drop and/or by a high-energy laser pump 806. The supercontinuum generation divides the energy of the single-frequency (ω) pulse among large frequency band dropping the energy at a frequency ω to a fraction of its initial value. A narrow pass-band filter 808 with a center frequency of ω filters out the other frequency components which deliver only the attenuated input pulse to the LIDAR sensor 810 which is below the optical damage threshold. If the incoming pulse is below the critical threshold for supercontinuum generation, above non-linear process does not take place and the input low-energy pulse reaches sensor with minimal attenuation. Using a Germania-core fiber at suitable conditions would create supercontinuum from 0.6-3.2-μm from a 1.55-μm input pulse with nanosecond pulse width. Assuming 10-nm FWHM supercontinuum pulses ensemble in the spectrum and assuming every pulse has equal energy density, the input power will attenuate by a factor of 260.

FIG. 8A shows a graphical representation of an example high energy pulse at frequency f, FIG. 8B shows a supercontinuum of the pulse of FIG. 8A into a large frequency band, and FIG. 8C shows a pulse at frequency f after filtering the signal of FIG. 8B. The filtered pulse of FIG. 8C has the same frequency as FIG. 8A at a lower energy level after frequency distribution in FIG. 8B.

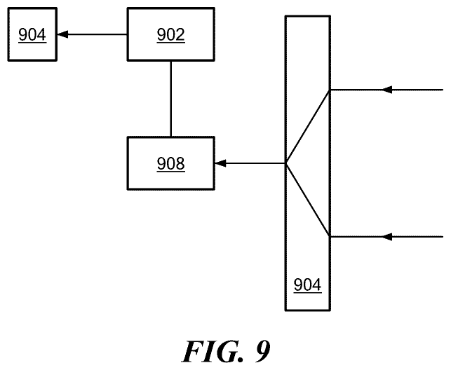

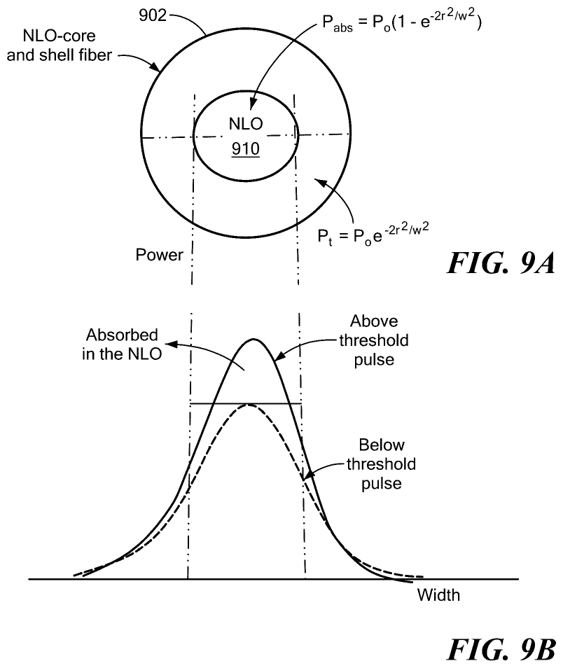

FIGS. 9, 9A, and 9B show another embodiment of an example receiver 900 for an optical sensor system, such as a LIDAR system, having optical protection with a core-shell non-linear optical fiber 902. An incoming pulse is collected and collimated by a collimator 904 and sent to the core-shell non-linear optical fiber 902, which sends signal to the sensor 906. A laser pump 908 can be coupled to the fiber 902.

In embodiments, the core-shell non-linear optical fiber 902 has a radius w where the core 910 up to a radius r is an NLO material. The incoming pulse has a beam-radius of w with the center of the Gaussian pulse at r=0. If the peak intensity of the incoming pulse is above a given threshold value (e.g., a Gaussian pulse outlined by a solid line) a non-linear process gets triggered in the NLO core region 910. If the NLO material 910 is a reverse-saturable NLO material some energy will be lost in the NLO material following two-photon absorption process.

The amount of power absorbed is a function of the radius of the core 910 and is given by P_{abs}=Pₒ(1−e^{-2r}^{²}^{/w}^{²}) where Po is the incoming pulse energy, r is the width of the core and w is the width of the core-shell fiber. The remaining energy Pₜ=Pₒe^{-2r}^{²}^{/w}^{²} goes to the sensor 906. With suitable optimization of the core-shell dimension and the two-photon absorption coefficient, the attenuation of the transmitted beam can be made to be less than the optical damage threshold of the sensor 906 which protects the LIDAR sensor from the high-energy input. The critical threshold for NLO process in the core-shell fiber is set either via a potential drop or by a high-energy laser pump 908.

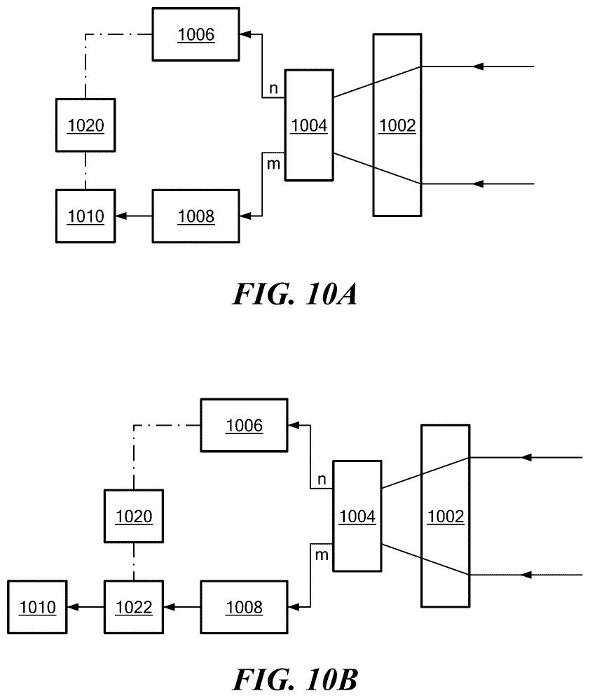

FIGS. 10A and 10B show further embodiments of example receivers 1000, 1000′ for an optical sensor system, such as a LIDAR system, having optical protection with collection optics 1002. The common elements of the systems 1000, 1000′ are described together. A linear optical splitter 1004 splits the collected incoming pulse to ratio of n:m where n<m. The n/(m+n) fraction of the incoming beam detected using a high-speed photodetector 1006. The m/(m+n) fraction of the input is sent to an optical delay line 1008 which gives a nominal optical delay of time t. A sensor 1010 receives a delayed optical signal under control of a controller 1020,

As shown in the embodiment 1000 of FIG. 10A, if the n/(m+n) fraction is above a given threshold which corresponds an input signal higher than the optical damage threshold of the LIDAR sensor 1010, the LIDAR sensor controller 1020 triggers to deactivate the LIDAR sensor 1010 deactivate.

As shown in the embodiment 1000′ of FIG. 10B, if the n/(m+n) fraction is above a given threshold which corresponds an input signal higher than the optical damage threshold of the LIDAR sensor 1010, an optical-switch actuator 1022 coupled to the delay line 1008 triggers to block the incoming beam from reaching the sensor 1010. The controller 1020 may be connected to the optical-switch actuator 1022.

In embodiments, control of the LIDAR sensor 1010 or optical-switch actuator 1022 occurs at a time of t′ where t′<<t. With this arrangement, potentially damaging high energy pulses will not reach the LIDAR sensor 1010. The delay-line time t subtracted from LIDAR data processing time will not result in errors under normal operation where below threshold optical inputs are received.

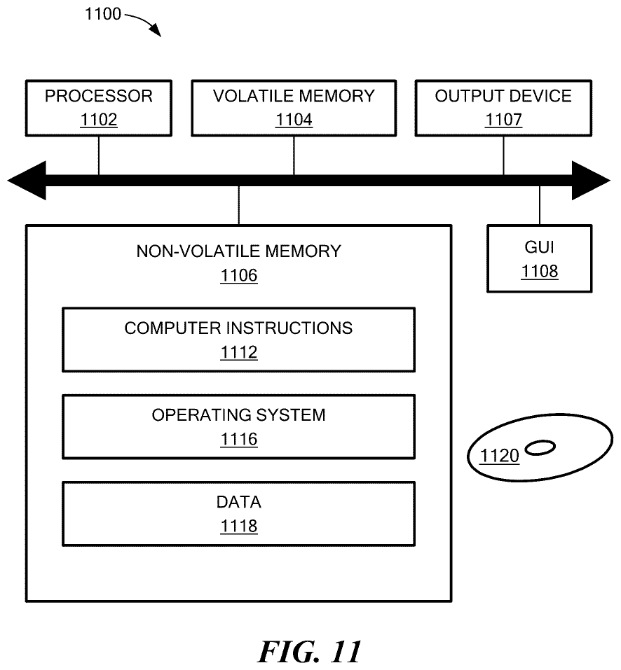

FIG. 11 shows an exemplary computer 1100 that can perform at least part of the processing described herein. The computer 1100 includes a processor 1102, a volatile memory 1104, a non-volatile memory 1106 (e.g., hard disk), an output device 1107 and a graphical user interface (GUI) 1108 (e.g., a mouse, a keyboard, a display, for example). The non-volatile memory 1106 stores computer instructions 1112, an operating system 1116 and data 1118. In one example, the computer instructions 1112 are executed by the processor 1102 out of volatile memory 1104. In one embodiment, an article 1120 comprises non-transitory computer-readable instructions.

Processing may be implemented in hardware, software, or a combination of the two. Processing may be implemented in computer programs executed on programmable computers/machines that each includes a processor, a storage medium or other article of manufacture that is readable by the processor (including volatile and non-volatile memory and/or storage elements), at least one input device, and one or more output devices. Program code may be applied to data entered using an input device to perform processing and to generate output information.

The system can perform processing, at least in part, via a computer program product, (e.g., in a machine-readable storage device), for execution by, or to control the operation of, data processing apparatus (e.g., a programmable processor, a computer, or multiple computers). Each such program may be implemented in a high-level procedural or object-oriented programming language to communicate with a computer system. However, the programs may be implemented in assembly or machine language. The language may be a compiled or an interpreted language and it may be deployed in any form, including as a stand-alone program or as a module, component, subroutine, or other unit suitable for use in a computing environment. A computer program may be deployed to be executed on one computer or on multiple computers at one site or distributed across multiple sites and interconnected by a communication network. A computer program may be stored on a storage medium or device (e.g., CD-ROM, hard disk, or magnetic diskette) that is readable by a general or special purpose programmable computer for configuring and operating the computer when the storage medium or device is read by the computer.

Processing may also be implemented as a machine-readable storage medium, configured with a computer program, where upon execution, instructions in the computer program cause the computer to operate.

Processing may be performed by one or more programmable embedded processors executing one or more computer programs to perform the functions of the system. All or part of the system may be implemented as special purpose logic circuitry (e.g., an FPGA (field programmable gate array) and/or an ASIC (application-specific integrated circuit)).

Having described exemplary embodiments of the disclosure, it will now become apparent to one of ordinary skill in the art that other embodiments incorporating their concepts may also be used. The embodiments contained herein should not be limited to disclosed embodiments but rather should be limited only by the spirit and scope of the appended claims. All publications and references cited herein are expressly incorporated herein by reference in their entirety.

Elements of different embodiments described herein may be combined to form other embodiments not specifically set forth above. Various elements, which are described in the context of a single embodiment, may also be provided separately or in any suitable subcombination. Other embodiments not specifically described herein are also within the scope of the following claims.

What is claimed is:

1. A LIDAR optical receiver system, comprising:
an optic to receive an optical signal;
an optical filter to control an output from the optic; and
an optical sensor to receive an output from the optical filter.

2. The system according to claim 1, wherein the optic comprises a lens and the optical filter comprises a non-linear optical (NLO) element to receive an output from the lens, wherein the NLO element has an intensity dependent optical index.

3. The system according to claim 2, further including an aperture between the NLO element and the optical sensor.

4. The system according to claim 3, wherein the NLO element is configured to attenuate the output from lens when the output from the lens is above an optical damage threshold.

5. The system according to claim 4, wherein the NLO element is configured to attenuate the output from the lens by increasing divergence.

6. The system according to claim 4, further including an optical pump coupled to the NLO element to bias the optical damage threshold.

7. The system according to claim 2, wherein the NLO element is configured to attenuate the output from the lens when the output from the lens is above an optical damage threshold.

8. The system according to claim 7, wherein the NLO element is configured to attenuate by increasing absorption.

9. The system according to claim 7, wherein the NLO element is configured as a reverse-saturable absorber via a two-photon absorption above a critical optical irradiance at an input optical-frequency.

10. The system according to claim 8, further including an optical pump coupled to the NLO element to bias the optical damage threshold.

11. The system according to claim 1, wherein the optic comprises a lens to receive an optical signal and, the optical filter comprises a non-linear optical (NLO) element to receive an output from the lens, wherein the NLO element has an intensity dependent optical index, and further including:
a photodetector coupled to the NLO element;
an optical source to transmit an optical signal through the NLO element to the photodetector; and
a controller coupled to an output of the photodetector and to the sensor, wherein the controller is configured to control the sensor based on the output of the photodiode.

12. The system according to claim 11, wherein the controller is configured to deactivate the sensor based on the output of the photodiode.

13. The system according to claim 1, wherein the optic comprises a collimator to receive an incoming optical pulse and the optical filter comprises a non-linear optical fiber to receive a signal from the collimator, wherein the fiber is configured to output a supercontinuum of coherent optical frequencies if the signal from the collimator is above a threshold, and further including:
a passband filter to filter an output from the optical fiber;
a sensor to receive an output from the passband filter; and
a laser pump coupled to the optical fiber.

14. The system according to claim 1, wherein the optic comprises a collimator to receive an incoming optical pulse and the optical filter comprises a non-linear optical fiber to receive an output from the collimator, wherein the fiber includes a core and shell configuration and is configured to absorb energy from the output from the collimator if a peak intensity of the output from the collimator is above a threshold, and further including:
a laser pump coupled to the optical fiber.

15. The system according to claim 1, wherein the optic comprises a collection optic to receive an optical input signal and the optical filter comprises a splitter to split an output from the collection optic into first and second signals in a ratio of n:m, and further including:
a photodetector to receive the first signal;
a delay module to receive the second signal;
a controller coupled to the photodetector; and
a sensor to receive an output from the delay module.

16. The system according to claim 15, further including a switch coupled to the controller, wherein the switch is coupled between the sensor and the delay module.
